(19) United States
(12) Patent Application Publication
(10) Pub. No.: US 2004/0056901 A1
(43) Pub. Date: Mar. 25, 2004

(54) Method, apparatus and system for representing relationships using a buddy list

(76) Inventors: Wendy A. March, Portland, OR (US); Nicholas W. Oakley, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/253,031

(22) Filed: Sep. 24, 2002

(51) Int. Cl. G09G 5/00

(52) U.S. Cl. 345/811; 345/864

(57) ABSTRACT

A method, apparatus and system display buddy list information according to predefined relationship criterion. More specifically, a user may create a buddy list having a plurality of entries, rank the entries according to a predefined relationship criteria, and view visual representations of the entries in the buddy list on a display device. The visual representations are displayed on the display device according to the rank assigned to each entry.

### FIELD OF THE INVENTION

The present invention relates to the field of electronic communications, and more particularly to using buddy lists to represent and display a variety of relationships.

### BACKGROUND OF THE INVENTION

Various forms of electronic communication have become widely accepted today and utilization of these forms of communication is growing daily. Electronic mail, for example, is now a standard form of communication and information exchange for a growing percentage of the population. A variation on electronic mail, namely instant messaging or text messaging (hereafter collectively “instant messaging”), is also gaining in popularity, especially amongst the younger generation. Instant messaging allows users who are on a network concurrently to “chat” with each other via various devices. Instant messaging is generally available today to subscribers of online services such as America Online™ (“AOL”) and MSN Online™ (“MSN”), and to subscribers of certain paging and cellular telephone services.

Another feature offered by various online services is the ability for users to assign a group of other online service subscribers to “buddy lists.” Once a user has established a buddy list, when the user is online, he will be able to identify whether the individuals in his buddy list are also on-line. The buddy list feature is highly popular and frequently used by subscribers, especially to facilitate instant messaging.

FIG. 1 illustrates an example of how buddy lists may be implemented on an online service network (Network 100) today. Specifically, Clients 101 and 102 may be coupled via Network 100 to Server 150. Clients 101 and 102 may be any data processing device comprising a processor capable of executing instructions, a bus coupled to the processor to supply the instructions to the processor, and one or more machine-accessible media to store the processor instructions. Server 150 may also be a data processing device capable of being accessed via Network 100 with the use of appropriate software. The appropriate software for network access may be network-dependant and is generally well known in the art.

User A may log into Network 100 via Client 101. If, for example, User A had previously created three user-defined buddy lists, upon logging into Network 100, he may be presented with these buddy lists. For example, User A may have created one buddy list for individuals in his family, a separate buddy list for his co-workers, and yet another list for his friends or “buddies.” Upon logging in, User A may see a visual representation of these buddy lists, with information regarding whether any of the individuals are also online. This information may be presented to User A by some form of visual representation, such as an icon. The visual representations are traditionally sorted alphabetically, by names, email addresses or the like. Each visual representation may also include different display characteristics or different labels, for example, to indicate whether the individual is online.

FIG. 2 illustrates exemplary Display Screen 200 that User A may see when he logs in. As illustrated, in this screen, User A has three previously defined buddy lists, namely “Buddies,” “Family” and “Co-Workers.” Upon logging in, User A may determine which individuals in his various buddy lists are also on-line. As illustrated in FIG. 2, for example, User A may immediately determine that all of the individuals in his buddy lists are offline. In an alternate embodiment, User A may see an icon for each individual in his various buddy lists, but the display characteristics of each icon may be displayed differently, indicating whether the individual is online. The icons of those individuals who are not online may have some indication, such as being grayed out, indicating that the icon is inactive because the individual associated with the icon is unavailable. In yet other embodiments, the icons may also optionally have associated text indicating a status.

### BRIEF DESCRIPTION OF THE DRAWINGS

The present invention is illustrated by way of example and not limitation in the figures of the accompanying drawings in which like references indicate similar elements, and in which:

FIG. 1 illustrates how buddy lists are used in the prior art;

FIG. 2 illustrates an exemplary visual representation of a prior art buddy list;

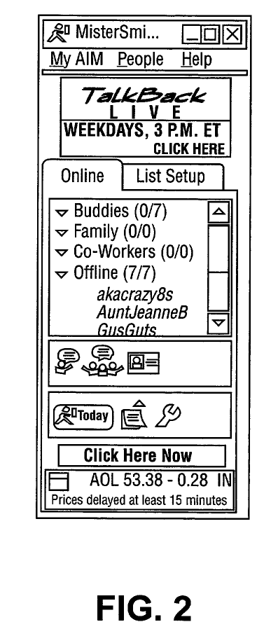

FIG. 3 illustrates an embodiment of the present invention;

FIG. 4 illustrates a visual representation of one embodiment of a buddy list;

FIG. 5 illustrates an embodiment of the present invention on a personal computer network;

FIG. 6 illustrates a visual representation of one embodiment of a buddy list; and

FIG. 7 illustrates an exemplary display according to an embodiment of the invention.

### DETAILED DESCRIPTION

Embodiments of the present invention enable a user to use buddy lists to represent different relationships and to present the user with logical visual representations of these buddy lists. According to one embodiment, users of various network services may create buddy lists wherein the contents of the buddy list may be ranked manually by the user or automatically, according to predefined relationship criteria. These ranked buddy lists may then be displayed according to configurations that visually represent the relationships between the users and the entries in the buddy lists according to the predefined relationship criteria. Thus, for example, according to embodiments of the invention, instant messaging users may rank and display selected icons representing individuals in their buddy list according to configurations that represent one or more predefined relationships between the user and the individuals in the buddy list. In other embodiments, cellular telephone users and/or users of various handheld devices may similarly rank and have their buddy lists displayed according to various predefined relationships.

Reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment.

According to embodiments of the present invention, users may create buddy lists, rank the contents of the lists (or have the contents ranked automatically) according to predefined relationship criteria, and have the ranked buddy lists displayed logically. Examples of relationship criteria include, but are not limited to, emotional distance, physical distance, geographical locations and/or conversational frequency. Other examples of relationship criteria that may be particularly appealing to the younger generation are “coolness,” “cuteness” and other such entertaining personal criteria. These buddy lists may be displayed on a variety of devices to present a visual representation of the ranked list. The visual representations present a user with a logical representation of the user's list.

Thus, for example, if the criterion is emotional distance, the icons or other visual representations of the individuals in the buddy lists may be displayed at different distances from an icon or other visual representation of the user to logically represent how the user regards a particular individual, e.g. the individuals whose icons are closest to the user's icon may be the ones that the user feels closest to. Regardless of the criteria used to rank the information, individuals on the buddy list may be presented visually according to a predefined ranking order, thus enabling the user to see this information at a glance. The predefined ranking order may be assigned manually by the user or assigned automatically. Predefined measurable relationship criteria may be assigned manually or automatically based on actual measured data (described in further detail below). Examples of predefined relationship criteria that may be measured are “conversational frequency” and “physical distance.” It will be readily apparent to those of ordinary skill in the art that certain intangible criteria such as “emotional distance,” “cuteness” and/or “coolness” may not be measurable and may therefore not be ranked automatically. In these embodiments where the relationship criteria may not be measurable, the ranking order may be assigned manually by the user. The term “ranking” in this specification may be used to interchangeably refer to both user rankings as well as automatically assigned rankings.

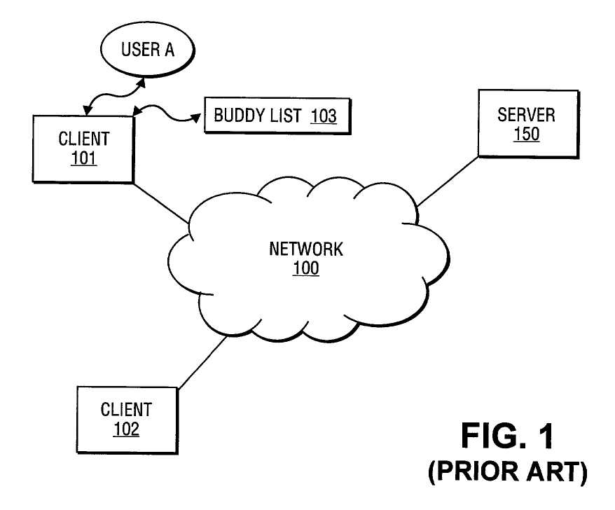

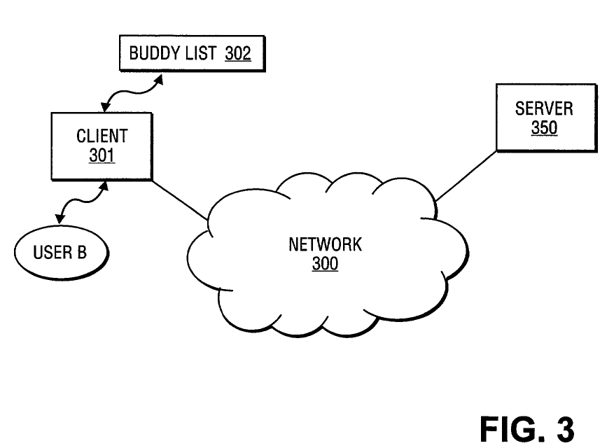

An embodiment of the present invention is illustrated in FIG. 3, where User B at Client 301 logs into Network 300 via Server 350. Similar to Server 150 in FIG. 1 above, Server 350 may be a data processing device capable of being accessed via Network 300 with the use of appropriate software. Client 301 may also be any data processing device. According to an embodiment, User B may create a buddy list according to a predefined relationship criterion such as “emotional distance.” According to this criterion, User B's buddy list will be ranked according to how close User B feels to each individual in the list. This measure of closeness may then be presented in a display format that visually represents the information. The display may also include status information, indicating whether individuals in the buddy list are currently available on Network 300.

More specifically, User B may create exemplary Buddy List 302 that includes the following individuals: Mom, Dad, Sister, Brother and Friend. User B may apply an emotional distance relationship criteria and rank the list as follows: Friend, Brother, Mom, Dad and Sister, according to the individuals to whom User B feels the closest. User B may manually order the names according to a rank. Alternatively, User B may assign a value to each individual in Buddy List 302 wherein the value indicates the individual's rank relative to the other individuals in the list. It will be readily apparent to one of ordinary skill in the art that Buddy List 302 may be ranked in a variety of ways, either by the user or automatically, without departing from embodiments of the present invention. User B may also optionally assign visual representations to each individual in Buddy List 302. These visual representations may be created and/or provided by User B, or selected from a predetermined list of visual representations created and/or provided by Server 350. Alternatively, User B may elect to have default visual representations assigned by Server 350.

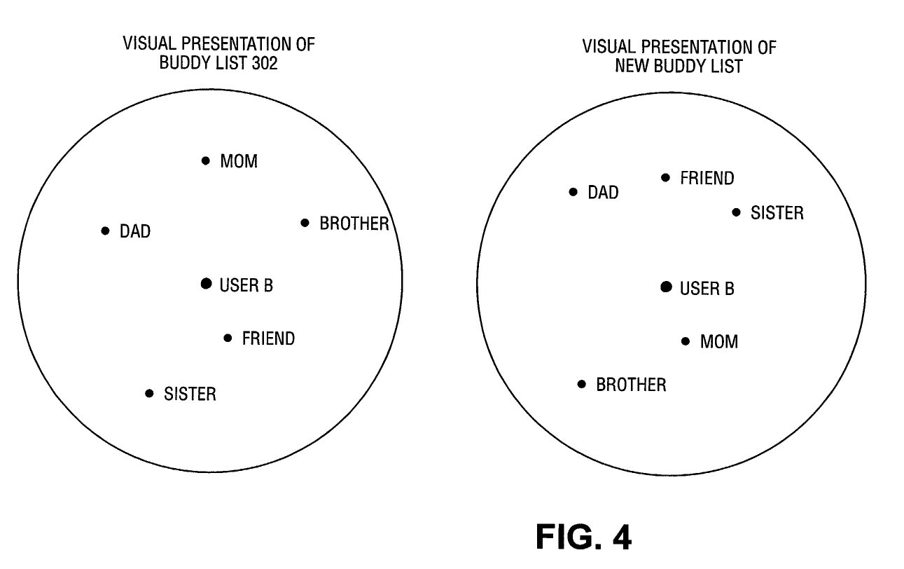

The ranked list may be visually presented to User B on a display device on, or coupled to, the data processing device. A visual representation of one embodiment of Buddy List 302 is illustrated in FIG. 4. It will be readily apparent to one of ordinary skill in the art that a variety of visual representations may be utilized to represent this information without departing from embodiments of the present invention.

According to one embodiment, User B may freely re-sort the list at any time. This process of re-sorting may occur in a number of ways. For example, in an embodiment, User B may re-sort the entries in Buddy List 302, thus altering the visual representation. In an alternative embodiment, User B may simply manipulate the visual representation of Buddy List 302, to alter the ranking of the individuals in Buddy List 302, and the entries in Buddy List 302 may thus be automatically re-sorted. Additionally, according to an embodiment, User B may freely add individuals to the list and re-sort the individuals according to the same relationship criteria.

Alternatively, User B may create another buddy list (“New Buddy List”) including the same individuals sorted according to different relationship criteria. Although Buddy List 302 and New Buddy List may include the same individuals, the visual display of the information contained in each buddy list may be different, as illustrated in FIG. 4. As illustrated, User B may create New Buddy List including the individuals from Buddy List 302, and New Buddy List may be re-sorted according to a “conversational frequency” criterion, i.e. User B may sort the names in the new buddy list according to the individuals with whom User B most frequently talks.

In an alternate embodiment, however, User B may simply enter names of individuals in Buddy List 302 and the names may be automatically ranked according to the measurable conversational frequency criterion. Thus, for example, Buddy List 302 may be automatically ranked according to the conversational frequency criterion by examining the actual number of calls placed to and/or received from particular individuals and ranking the individuals according to the frequency of such calls. It will be readily apparent to one of ordinary skill in the art that measuring and/or examining data to automatically rank entries in a buddy list may be performed in a variety of ways. According to one embodiment, automatic ranking may be performed by Client 301, while in alternate embodiments, this function may be performed by Server 350. In yet other embodiments, automatic ranking may be performed by one or more data processing devices coupled to Client 301 and/or Server 350.

For the purposes of illustration, the above description of various embodiments of the present invention presumes the use of a data processing device having, or coupled to a display device, and a service provider capable of providing network services to the data processing device. It will be apparent that data processing devices according to embodiments of the present invention may include, but are not limited to, personal computers (“PCs”), various types of handheld devices such as personal digital assistants (“PDAs”), cellular telephones, pagers and/or any other type of device having data processing capabilities and a display device or access to a display device. Thus, the general description of the invention above may be specifically implemented on a variety of devices and across a variety of networks to achieve the same or similar results.

According to one embodiment, data processing devices may include various components capable of executing instructions to accomplish an embodiment of the present invention. For example, the data processing devices may include and/or be coupled to at least one machine-accessible medium. As used in this specification, a machine-accessible medium includes any mechanism that stores and/or transmits information in any form accessible by a data processing device, the machine-accessible medium including but not limited to, recordable/non-recordable media (such as read only memory (ROM), random access memory (RAM), magnetic disk storage media, optical storage media and flash memory devices), as well as electrical, optical, acoustical or other form of propagated signals (such as carrier waves, infrared signals and digital signals).

According to an embodiment, a data processing device may include various other well-known components such as one or more processors. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. A host bus host controller such as a Universal Serial Bus (“USB”) host controller may be coupled to the bus(es) and a plurality of devices may be coupled to the USB. For example, user input devices such as a keyboard and mouse may be included in the data processing device for providing input data.

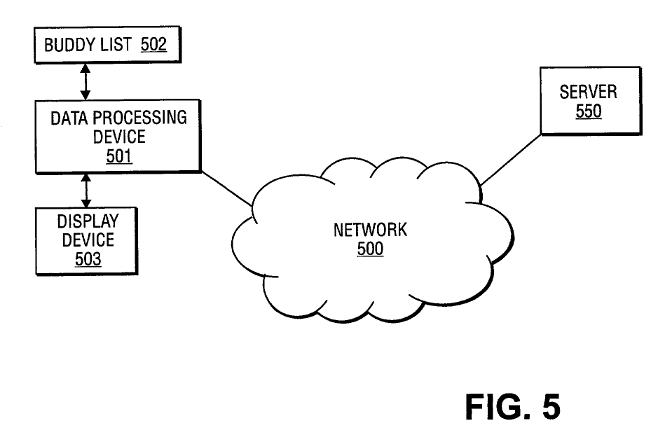

FIG. 5 illustrates an embodiment of the present invention on a personal computer network. As illustrated, Data Processing Device 501 is a personal computer coupled to Server 550 via Network 500. Network 500 may be an online service provider network such as AOL™ and/or MSN™. According to one embodiment, User C may create Buddy List 502 and sort the individuals in the list according to an “emotional closeness” relationship criterion. Similar to the general example illustrated in FIG. 4 above, Buddy List 502 may be ranked as follows: Friend, Brother, Mom, Dad and Sister, according to the individuals that User C feels closest to emotionally.

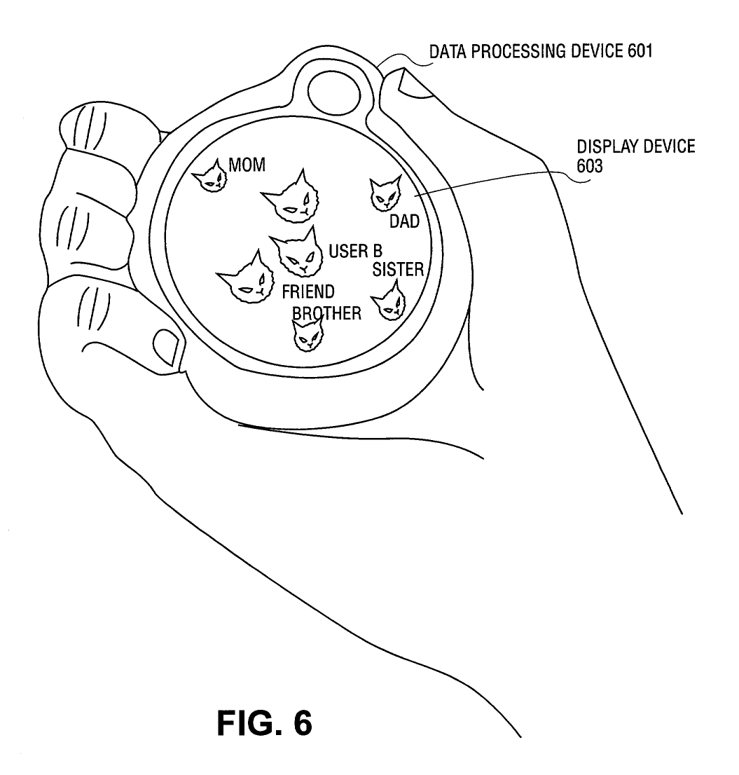

Data Processing Device 501 may include and/or be coupled to Display Device 503 and a visual representation of one embodiment of sorted Buddy List 502 may be displayed on Display Device 503. In this embodiment, icons are used as visual representations of each of the entries in Buddy List 502. In alternate embodiments, colored indicators (e.g. colored shapes) or other such distinguishing visual representations may be utilized. As illustrated in FIG. 6, Buddy List 502 may be displayed using polar coordinates, with an icon representing User C being displayed in the center of the polar coordinates. The icons closest to User C indicate the individuals with whom User C feels the closest (in this case, Friend). It will be readily apparent to one of ordinary skill in the art that the display illustrated in FIG. 6 is merely exemplary and that numerous other display configurations may be implemented to convey the same or similar information.

According to one embodiment, by selecting an icon that shows that a particular user is online, User C may automatically contact that person. Thus, for example, according to one embodiment, User C may select the icon for “Friend” and open an instant messaging dialogue with that person. In an alternate example, Network 500 may be a cellular telephone network and Data Processing Device 501 may be a cellular telephone. By selecting the icon for “Friend” on the display device on, or coupled to, the cellular telephone, the user may automatically dial the phone number for Friend.

It will be readily apparent to those of ordinary skill in the art that the icons representing the individuals in the buddy list may be associated with unique attributes of the individuals, to enable the networks to identify the individuals. In the embodiment where Data Processing Device 501 is a personal computer, for example, the unique attribute of the individuals in Buddy List 502 may be an Internet Protocol (“IP”) address associated with each individual. These IP addresses are generally assigned and managed by Server 550. In the alternate embodiment where Data Processing Device 501 is a cellular telephone, on the other hand, the unique attribute of the individuals in Buddy List 502 may be their telephone numbers. System management of IP addresses and telephone numbers are known in the art and further description of such is omitted herein in order not to obscure the present invention. It will also be readily apparent to those of ordinary skill in the art that various other unique attributes may be utilized without departing from the spirit of the present invention.

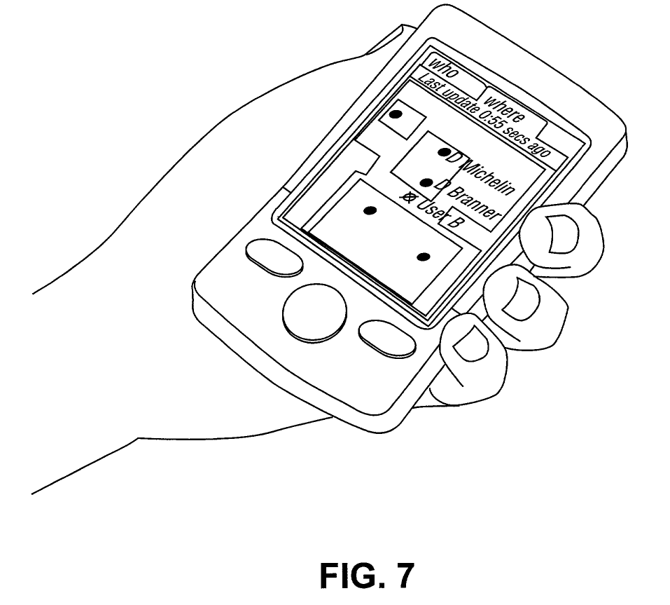

Embodiments of the invention may also be implemented on devices that are designed to recognize a “physical distance” relationship criterion. The physical distance relationship criterion may provide users with a visual representation of the actual location of various individuals on a particular network. In the interest of privacy, users are likely to be able to keep track of only those individuals who permit their devices to be recognized by other subscribers on a network. For example, devices such as cellular telephones today automatically transmit information regarding their location to servers on various cells on a cellular telephone network and receive data from the network. According to one embodiment of the present invention, individuals with cellular telephones may permit the cellular telephone network provider to provide this location information to selected individuals on the network. This information may be provided to the user in a display such as that illustrated in FIG. 7. According to this embodiment, the ranking criterion for the buddy list is automatically assigned according to the measured physical distance between the user and the individuals in the buddy list. This measurement of physical distance may be performed in a variety of ways, including, for example, using positions on a map to calculate a distance. It will be readily apparent to one of ordinary skill in the art that the physical distance measurable criterion may be calculated in numerous ways without departing from the spirit of embodiments of the invention.

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method of representing relationships with a buddy list, comprising:
creating a buddy list having a plurality of entries; and
assigning a rank to each of the plurality of entries according to a relationship criterion.

2. The method according to claim 1 further including displaying visual representations for each of the plurality of entries, wherein display of the visual representations is based at least in part on the rank.

3. The method according to claim 2 wherein the visual representations are displayed at predetermined locations on a display device, the predetermined locations based at least in part on the rank.

4. The method according to claim 2 wherein the visual representations for each of the plurality of entries includes a status indicator for each of the plurality of entries.

5. The method according to claim 1 wherein assigning the rank further comprises assigning the rank according to at least one of a conversational frequency, a physical distance and an emotional distance.

6. The method according to claim 1 further comprising assigning visual representations to each of the plurality of entries in the buddy list.

7. The method according to claim 6 wherein the visual representations comprise at least one of an icon and a colored indicator.

8. The method according to claim 1 wherein assigning the rank includes accepting as input data the rank for each of the plurality of entries in the buddy list.

9. A method of displaying a buddy list having a plurality of entries, comprising:
receiving the buddy list;
assigning a rank for each of the plurality of entries in the buddy list, the rank based on a predefined relationship criterion; and
causing display of a plurality of visual representations corresponding to the plurality of entries in the buddy list, the plurality of visual representations being displayed at predefined locations on a display device based on the rank.

10. The method according to claim 9 further comprising:
defining a location on the display device representing a user; and
causing display of the plurality of visual representations at different distances from the location representing the user, the different distances visually representing the rank of each of the plurality of entries in the buddy list.

11. The method according to claim 10 wherein receiving the rank based on the predefined relationship criterion further comprises receiving the rank based on at least one of a conversational frequency and an emotional distance.

12. The method according to claim 9 wherein the plurality of visual representations further comprise a status indicator.

13. The method according to claim 9 wherein assigning the rank includes accepting as input data the rank for each of the plurality of entries in the buddy list.

14. An apparatus for displaying a buddy list having a plurality of entries, comprising:
a processor capable of receiving the buddy list and a rank associated with each of the plurality of entries in the buddy list, the rank based on a predefined relationship criterion, the processor further capable of causing display of a plurality of visual representations corresponding to each of the plurality of entries, the visual representations displayed at predefined locations based on the rank; and
a display device capable of displaying the plurality of visual representations.

15. The apparatus according to claim 14 wherein the predefined relationship criterion is at least one of a conversational frequency, a physical distance and an emotional distance.

16. A user interface for displaying a buddy list having a plurality of entries, comprising:
a visual representation of an owner of the buddy list displayed at a first location on a display device; and
a plurality of visual representations corresponding to the plurality of entries in the buddy list, the plurality of visual representation displayed at predetermined distances from the first location on the display device based on a rank of each of the plurality of entries.

17. The user interface according to claim 16 wherein the rank of each of the plurality of entries is based on a predefined relationship criterion.

18. The user interface according to claim 17 wherein the predetermined relationship criterion includes a least one of a conversational frequency, a physical distance and an emotional distance.

19. A system for representing relationships using a buddy list, comprising:
a network;
a client device coupled to the network, the client device capable of accepting input data from a user, the input data including a plurality of entries for the buddy list and designation of a rank for each of the plurality of entries in the buddy list, the rank based on a predefined relationship criterion;
a server device coupled to the network, the server device capable of receiving the buddy list and the designation of the rank from the client device; and
a display device coupled to the client device, the display device capable of displaying at predetermined locations visual representations corresponding to the plurality of entries in the buddy list, the predetermined locations based on the rank.

20. The system according to claim 19 wherein the network comprises one of an online service network and a cellular telephone network.

21. The system according to claim 19 wherein the client device comprises one of a personal computer, a cellular telephone and a handheld device.

22. The system according to claim 19 wherein the server device comprises a data processing device.

23. The system according to claim 19 wherein the display device comprises one of a monitor, a display on a cellular telephone and a display on a handheld device.

24. An article comprising a machine-accessible medium having stored thereon instructions that, when executed by a machine, cause the machine to display a buddy list by:
receiving the buddy list having a plurality of entries;
assigning a rank for each of the plurality of entries in the buddy list, the rank based on a predefined relationship criterion; and
causing display of a plurality of visual representations corresponding to the plurality of entries in the buddy list, the plurality of visual representations being displayed at predefined locations on a display device based on the rank.

25. The article according to claim 24 wherein the instructions that, when executed by the machine, cause the machine to display the buddy list having the plurality of entries by further:
defining a location on the display device representing a user; and
causing display of the plurality of visual representations at different distances from the location representing the user, to visually represent the predefined relationship criterion.

26. The article according to claim 24 wherein assigning the rank includes receiving as input data the rank for each of the plurality of entries in the buddy list.

27. An article comprising a machine-accessible medium having stored thereon instructions that, when executed by a machine, cause the machine to display a buddy list by:
creating a buddy list having a plurality of entries; and
assigning a rank to each of the plurality of entries according to a relationship criterion.

28. The article according to claim 27 wherein assigning the rank includes accepting as input data the rank for each of the plurality of entries in the buddy list.

29. The article according to claim 27 wherein the instructions that, when executed by the machine, cause the machine to display the buddy list having the plurality of entries by further viewing a display of visual representations for each of the plurality of entries, wherein the display is based at least in part on the rank.

30. The article according to claim 27 wherein the instructions that, when executed by the machine, cause the machine to display the buddy list having the plurality of entries by further viewing the display of the visual representations further comprises viewing the visual representations displayed at predetermined locations on a display device, the predetermined locations based at least in part on the rank.
